(19) United States
(12) Patent Application Publication
(10) Pub. No.: US 2007/0182340 A1
(43) Pub. Date: Aug. 9, 2007

(54) Fluorescent tube electronic rectifier

(76) Inventor: Zhang Ding Lu, Yi Yang City (CN)

Correspondence Address: LOWE HAUPTMAN BERNER, LLP, 1700 DIAGONAL ROAD, SUITE 300, ALEXANDRIA, VA, 22314, US

(21) Appl. No.: 11/349,942

(22) Filed: Feb. 9, 2006

(51) Int. Cl. H05B 39/04; H05B 41/36

(52) U.S. Cl. 315/209 R

(57) ABSTRACT

The present invention is to provide a fluorescent tube electronic rectifier which comprises an inverter circuit and an inductance rectifier wherein the inverter circuit has an output end to be connected to one end of a fluorescent tube and the inductance rectifier has also an output end to be connected to the other end of the aforementioned fluorescent tube. Both the inverter circuit and the inductance rectifier have an input end to be connected to a suitable current source in order to lower the value of the current peak and increase their ability to anti-jam.

### FIELD OF THE INVENTION

The present invention relates to a fluorescent lamp seat, and more particularly to a fluorescent tube electronic rectifier.

### DESCRIPTION OF THE PRIOR ART

Nowadays, the traditional fluorescent lamp tube electronic rectifier makes use of an inverter circuit A to light the fluorescent lamp by producing high-frequency and high-voltage at the two ends of a fluorescent tube B (as shown in FIG. 1). However, the following defaults occur under this kind of circuit structure: 1. The peak value of the current is so high that the lamp tube can easily turn dark and the service life will thus be affected; 2. The content of resonance is so high that the interfere becomes even more serious; 3. The stability of the form of entire electron is not enough.

### SUMMARY OF THE INVENTION

In order to overcome the above-mentioned problems, the objective of present invention is to provide new type of fluorescent tube electronic rectifier.

For achieving this objective, the present invention provides a fluorescent tube electronic rectifier which includes an inverter circuit and an inductance rectifier; one side of the fluorescent tube is to connected to the output end of the inverter circuit and the other end of it is to connected to the output end of the output end of the inductance rectifier. Both of the inverter circuit and the inductance rectifier have an input end to be connected to a suitable current source.

The following advantages can thus be attained: 1. By connecting one side of the fluorescent tube to the inverter circuit to produce high frequency and high voltage and the other side to the inductance rectifier to produce power frequency voltage, the peak value of the current of the fluorescent tube is less than 1.7 to avoid the darkness at the two end of the light tube and lengthen its the service life; the problem of early darkness of the traditional electronic rectifier can thus be solved. 2. The combination of the inductance and the electron can provide a higher stability, lower content of resonance and better ability of anti-jam.

### BRIEF DESCRIPTION OF THE DRAWING

FIG. 1 is the connection layout of the traditional electronic rectifier and the fluorescent tube.

FIG. 2 is the block diagram of the preferred embodiment of the present invention.

FIG. 3 is the circuit diagram which corresponds to the FIG. 2.

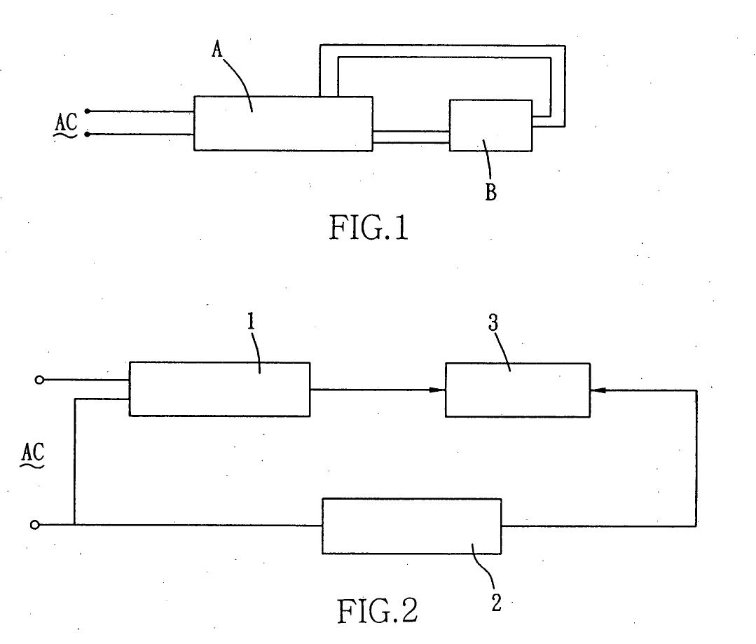

### DESCRIPTION OF THE PREFERRED EMBODIMENT

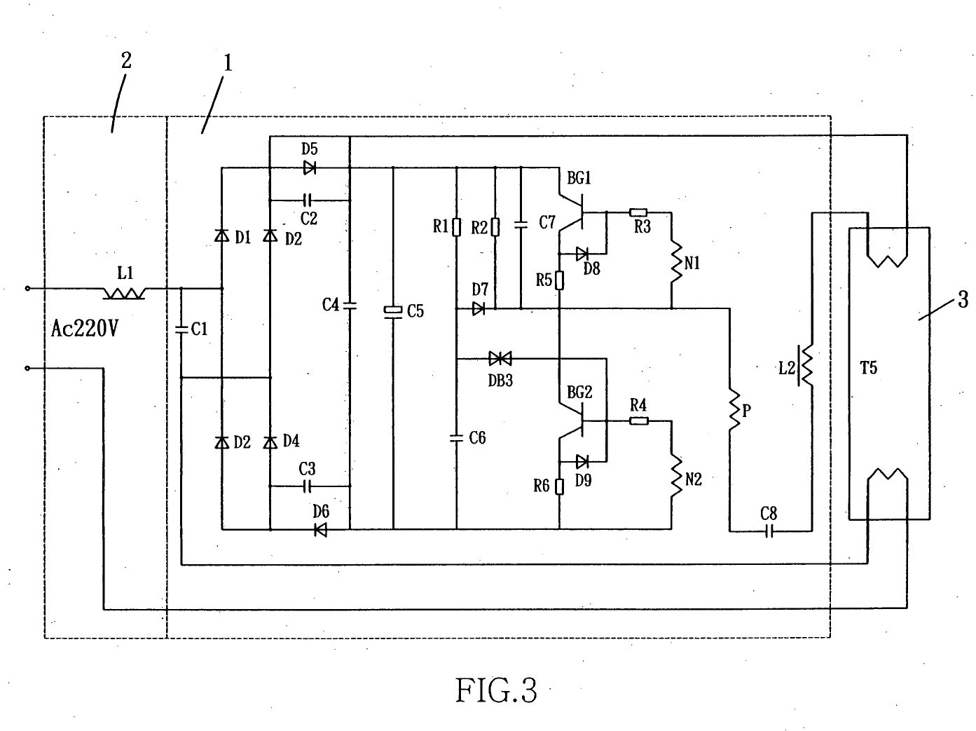

As shown in FIG. 2 and FIG. 3, the present invention of fluorescent tube electronic rectifier comprises: an inverter circuit (1), an inductance rectifier (2). A fluorescent tube (3), which can be of T5 or T8 type, has its one end connected to the output end of the inverter circuit (1) and its other end connected to the output end of the inductance rectifier (2) while the input ends of the inverter circuit (1) and the inductance rectifier (2) are connected to a power supply.

In each of the attached figures, L1 is a inductance rectifier, D1-D9 are diodes, C2-C8 are capacitances, R1-R6 are electric resistances, while triodes BG1 and BG2, inductance L2, N1, N2 and P combined to form a inverter circuit (1) and capacitances C7, C8 and inductance L2 create jointly a LC resonance oscillation to produce high frequency and high voltage.

What we claim is:

1. A fluorescent tube electronic rectifier which comprising: an inverter circuit and an inductance rectifier wherein the inverter has an output end to be connected to one end of the fluorescent tube while the inductance rectifier has an output to be connected to the other end of the aforementioned fluorescent tube. Both the inverter circuit and the inductance rectifier have an input end to be connected to a suitable current source.
